(19) United States
(12) Patent Application Publication
(10) Pub. No.: US 2007/0050396 A1
(43) Pub. Date: Mar. 1, 2007

(54) Fast algorithm for building multimedia library database

(75) Inventors: Shu Kwan Roger Cheng, Tseung Kwan O (CN); Yiu Wing Ip, Kowloon (CN); Wan Yun So, Kowloon (CN)

Correspondence Address: BUCHANAN, INGERSOLL & ROONEY PC, POST OFFICE BOX 1404, ALEXANDRIA, VA, 22313-1404, US

(73) Assignee: PERCEPTION DIGITAL LIMITED, New Territories (CN)

(21) Appl. No.: 11/417,215

(22) Filed: May 4, 2006

Related U.S. Application Data
(60) Provisional application No. 60/677,845, filed on May 5, 2005.

(51) Int. Cl. G06F 7/00

(52) U.S. Cl. 707/102

(57) ABSTRACT

A method of building a database of multimedia files is presented that is designed to provide a fast algorithm to build the database in a digital multimedia device, having large capacity storage media but relatively slow access time and a limited amount of fast RAM memory space.

### FIELD OF THE INVENTION

This invention relates to a novel method for constructing a database, in particular a database of multimedia files stored in a multimedia player such as a portable MP3 music player.

### BACKGROUND TO THE INVENTION

MP3 based portable music players are very popular and may use either solid state flash memory or a hard disc. As the size of flash memory gets larger and the hard disc drive based players become more popular, it is desirable to create a database organizing the songs by album, by artist, by genre, and in either alphabetical or tack order within the same album or artist, for the ease of navigation across the large number of songs stored inside the player. However, whenever new songs are added to the device either from a PC or via the insertion of a flash memory card such as SD card or Multimedia Card (MMC), the database has to be amended before the user can access the added contents using the database structure.

Amending the database inside the player using the player itself in general takes a long time because of limited size of the fast memory (either internal RAM within the processor chip or external SPRAM inside the player). This limited memory space requires the database building process to access the much slower (large) memory storage, usually the flash or the hard disc drive, many times to obtain the song information as well as for temporary storage of the partially built database. To avoid this problem, most existing players require the device to be connected to the PC to build the database using a piece of customized software running on the PC. However this is rather inconvenient from the users' viewpoint. If the songs are downloaded from a PC without this customized software program, the database cannot be rebuilt or amended. Moreover if new songs are added by inserting a flash memory card to the player, but without connecting to a PC, the songs on the newly inserted flash memory card cannot be added to the database as well. Very few players allow the database to be rebuilt or amended using the player itself without connecting to any PC, the speed of the rebuilding is very slow and this is increasingly inconvenient especially with the increasing storage capacity of the flash memory cards.

### SUMMARY OF THE INVENTION

The present invention at least in its preferred forms is designed to solve or at least mitigate these and to provide a fast algorithm to build the database in a digital multimedia device with very large capacity storage media, but with a relatively slower access time, such as flash or hard disc drive, but very limited amount offast RAM memory space, either internal RAM or external SD-RAM.

In preferred embodiments of this invention there is disclosed a fast algorithm to create a database (hereinafter referred to as “the database”) of multimedia data including audio, photos, and/or video (hereinafter referred to as “media data”) in a digital multimedia player (hereinafter referred to as a “multimedia player”) with two kinds of memory storage of different access speeds.

The database is so created to facilitate fast access of media data inside the multimedia player for browsing, selecting, playing, copying, or searching an item or a list of items under certain desirable criteria on the metadata of the multimedia item The metadata are information about the multimedia item that will be used for categorizing or sorting inside the database. In many cases, the database will sort the items according to certain criteria on the metadata. For example, in a MP3 player, the songs (multimedia data) could be organized according to the artists, albums, genre, year, etc, (example of the metadata) in the database so that the list of songs under an album can be obtained quickly for user interface.

A multimedia player typically has two kinds of memory storage. For example, a portable flash-based MP3 player has flash memory and RAM (either internal or external to the processor) and the access speed for the flash memory is much slower than that of RAM. Another possible example is a hard disc drive (HDD) based MP3 player that has ND)) and RAM. In this case, the ND)) is a slower memory storage when compare to RAM. The possibility of two kinds of memory storage with different access speeds can also encompass two forms of the same type of memory, e.g. a RAM-only multimedia player with internal and external RAM where the internal RAM can be accessed faster than the external RAM because of different wait state requirements.

It is desirable to build a database or to amend a database after new media data is added to the multimedia player. Typically, the media data are stored in the memory storage with the slower access time and to retrieve the metadata, access to this slower memory storage is required. The process of building and amending data to the database can require a long time to accomplish, especially when the relatively fast memory storage in the device is rather limited in size and cannot be used to hold all the data needed inside the database. The present invention provides a fast method or algorithm to build a database for this purpose. The algorithm is fast because it keeps the access to the slower memory storage to a minimal number of occasions, and it keeps to a minimum the number of times that it is required to retrieve the metadata.

According to the present invention there is provided a method for building a database relating to media data stored in a multimedia player wherein said multimedia player has a first memory storage of relatively slow access time and a second memory storage of relatively fast access time, wherein said database comprises name lists, sorted ID lists, association lists, and number lists, and wherein during the building of the database the sorted ID lists, association lists and number lists are stored in the relatively fast second memory storage and only the name lists are stored in the relatively slow first memory storage.

In this way the speed with which the database can be created is increased since only if it is necessary to access a name list is it necessary to access the relatively slow first memory storage.

More preferably still skeleton form(s) of the name list(s) may be provided in the relatively fast second memory storage as anchored point tables. These anchored point tables will include data from regularly spaced locations in the name list(s) and may be used to conduct a first iteration in the relatively fast second memory of where a new item to be entered into the database is to be inserted in the name list(s). This first iteration will reduce the number of possible locations in the name list(s) where a new item may need to be inserted and thus reduce the building time.

The present invention further provides a method of building a database of multimedia files stored in slow memory using metadata of the multimedia files in a multimedia player running on a processor with fast memory and slow memory, the method comprising the steps of retrieving the metadata from each multimedia file residing in the slow memory only once and storing the retrieved metadata in an array in a database in the slow memory directly and only once.

The data in various fields inside the metadata of a multimedia file will be stored in data arrays of these fields in the slow memory after it is obtained from the metadata of the multimedia file, and will be discarded before the metadata of the next multimedia file is retrieved. All other link lists, not including the data arrays, are stored in the fast memory throughout the building process of the database, until the final list structure is created and is then stored to the slow memory.

Further, a skeleton form of a name list is created and stored in the fast memory so that the first few steps of a binary search can be performed using the fast memory only to restrict the further binary search involving the slow external memory to a narrowed range in the name list. The number of steps in the binary search involving the external memory is bound by a predetermined constant to provide certain guarantee on the search time, by using the proper size of the skeleton form of the name list in the fast memory. All the final output link lists that need to be created in the final database will only be written to the slow memory at the end of the database building process which is the time when no further access to those lists is required for the rest of the building process, to ensure that once a list is written to the slow memory, no further access is need to that list.

The present invention additionally provides a method of building a database of multimedia files stored in slow memory using metadata of the multimedia files in a multimedia player running on a processor with fast memory and slow memory, the method comprising the steps of retrieving the metadata from each multimedia file once, writing the metadata of each multimedia file into the database once, and writing the output of all other output files in the database once. The number of times for reading the data from the metadata data list stored in the slow memory is predetermined by the number of categories in the metadata and the number of multimedia files.

### BRIEF DESCRIPTION OF DRAWINGS

Some embodiments of the present invention will now be described by way of example and with reference to the accompanying drawings, in which:

FIG. 1 is a block diagram of a typical multimedia device, and

FIG. 2 is an illustration of the link structure and modification method used in embodiments of the present invention.

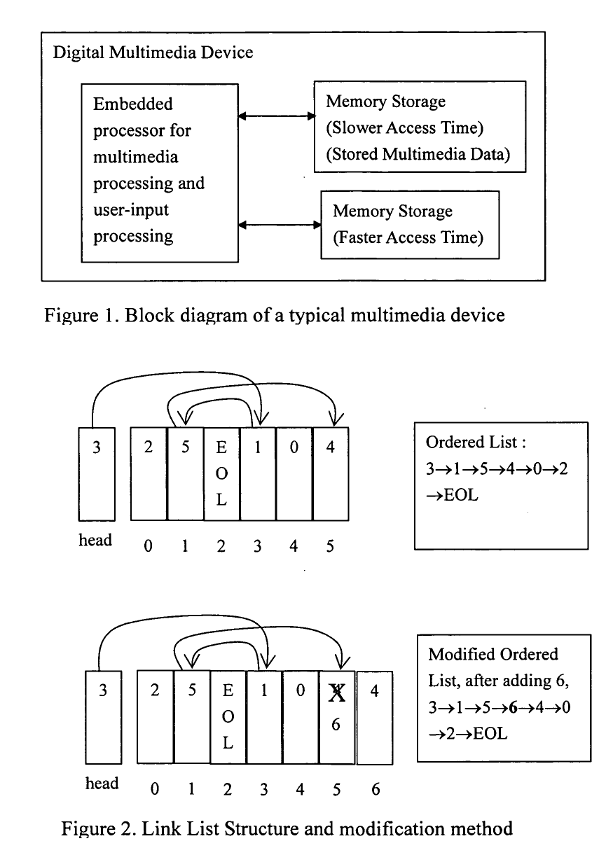

### DETAILED DESCRIPTION OF PREFERRED EMBODIMENTS OF THE INVENTION

The embodiments described herein are for the building of a music library for a flash based MP3 player (it will be understood however that embodiment of the invention could be applied to the building of other databases, in particular databases of other media data). Each song has an associated artist, album, genre, and year. The music library is a database that allows fast and easy retrieval of songs under a particular artist, album, genre type or year. Songs are sorted in alphabetical order under each album, artist, genre or year. The resulting music library consists of multiple lists including an artist list, an album list, a genre list and a song list sorted alphabetically. Each song will appear under only one artist, album and genre.

Final Outcome of the Building Algorithm

The following lists are the final outcomes of the building algorithm and these lists are stored in the flash memory (the slower, but larger size) for ease of browsing.
1. Sorted ID Lists
   a) Sorted Song ID List—List of Song IDs sorted according in the alphabetical order of the song name
   b) Sorted Album ID List—List of Album IDs sorted according in the alphabetical order of the album name
   c) Sorted Artist ID List—List of Artist IDs sorted according in the alphabetical order of the artist name
   d) Sorted Genre ID List—List of Genre IDs sorted according in the alphabetical order of the genre name
2. Name Lists
   a) Song Name List—List of song names listed according to the song ID.
   b) Album Name List—List of album names listed according to the album ID.
   c) Artist Name List—List of artist names listed according to the artist ID.
   d) Genre Name List—List of genre names listed according to the genre ID.
3. Association ID Lists
   a) Album-Song ID List—List of Song IDs sorted according to their album names alphabetically first and then their song names alphabetically.
   b) Artist-Song ID List—List of Song IDs sorted according to their artist names alphabetically first and then their song names alphabetically.
   c) Genre-Song ID List—List of Song IDs sorted according to their genre names alphabetically first and then their song names alphabetically
4. Num_of_Songs Lists
   a) Tot_Song_in_Album List—Tot_Song_in_Album(n) gives the number of songs in the album whose ID is in the n position in the Album-Song ID List
   b) Tot_Song_in_Artist List—Tot_Song_in_Artist(n) gives the number of songs in the artist whose ID is in the n position in the Artist-Song ID List c) Tot_Song_in_Genre List—Tot_Song_in_Genre(n) gives the number of songs in the genre whose ID is in the n position in the Genre-Song ID List

In fact, depends on the metadata, additional lists including both sorted ID list, Name list and Associated ID list can be generated for new field such as year, can be generated as desired using the same algorithm described in below.

Building Algorithm to Generate These Lists Shown in the Last Section

The building of the database consists of 3 stages:

Stage 1:
The songs in the main storage media are retrieved and their metadata are entered into the database. Also, unique ID is assigned to each song and similarly for each category including album, artist and genre. Songs will be sorted in this stage both alphabetically in a link list. An index table will be used to reduce the number of times the flash is to be accessed. The Name Lists will all be generated and stored in the flash at the end of this process. The following association arrays are also generated:
   1. Song's album ID array (SAlbID) is defined such that SAlbID(n) contains the album ID of the song with song ID n.
   2. Song's artist ID array (SArtID) is defined such that SArtID(n) contains the artist ID of the song with song ID n.
   3. Song's genre ID array (SGenID) is defined such that SGenID(n) contains the genre ID of the song with song ID n.

The following show the flow chart of the algorithm in stage 1:
1) SongID=AlbID=ArtID=GenID=0;
2) Initialize the Song_name, Album_name, Artist_name, and Genre_name Link Lists. (See FIG. 2 for link list structure.)
3) Get the first song and the metadata of this song from the flash, including song name, artist, album, and genre.
4) Add the song name to the end of Song Name List that is stored in the flash memory.
5) Assign SongID as the ID of this song, and increment SongID by 1.
6) Insert the newly added SongID into the Song_name Link Lists according to the alphabetical order of the song name using binary insertion search. The number of times the flash has to be accessed to get the song name for comparison in each insertion in each Link List is log₂(N) where N is the number of songs added so far. This search process is shortened in this invention by creating an Anchored Point Table which stored the some song names from the Song Name List. (See FIG. 2 for link list structure and the addition of an item into the link list)
7) For each type (including Album, Artist and Genre),
   8) Use the binary insertion search method to determine if the album (artist, genre) is a new item.
   9) If it is a new item, assign AlbID (ArtID, GenID) as the curAlbID (curArtID, curGenID) and increment the AlbID (ArtID, GenID). Insert the new item into the link list.
   10) If it exists already, assign the AlbID of the found album as the curAlbID.
   11) Update the Association array by letting SAlbID(SongID)=curAlbID, (SArtID(SongID)=curArtID, SGenID(SongID)=curGenID).
   12) Repeat 8)-11) for Artist and Genre
13) Get the next song and go back to 4)
14) Store the TotSongID=SongID+1, TotAlbID=AlbID+1, TotArtID=ArtID +1, and TotGenID=GenID+1.
15) Finish stage 1 if all songs are processed.

Stage 2:
Convert the association arrays into the associated link lists.
   1) Initialize the Alb_Head_ptr array with size TotAlbID with the “EOL” symbol (e.g. a special number larger than the maximum number of Albums and is used to indicate the end of a link list). Similarly, repeat for Artist and Genre to generate Art_Head_ptr arry and Gen_Head_ptr array.
   2) Trace the Song_name link list and for each song (denoting its songID as curSongID) do the following:
      3) If Alb_Head_ptr(SAlbID(curSongID))=“EOL”, then Alb_Head_ptr(SAlbID(curSongID))=curSongID and SAlbID(curSongID)=“EOL” and jump to step 6.
      4) Otherwise, trace the link list by setting nextSongID=Alb_Head_ptr(SAlbID(curSongID)) and repeatedly set nextSongID=SAlbID(nextSongID) if SAlbID(nextSongID) is not equal to “EOL”.
      5) Once we reach a node SAlbID(nextSongID)=“EOL”, set SAlbID(nextSongID)=curSongID and set SAlbID(curSongID)=“EOL”.
      6) Repeat Step 3-6 with Artist using Art_Head_ptr array and SArtID association array and Genre using Gen_Head_ptr array and SGenID association array.
   7) Go to the next song in the Song_name link list and jump back to step 3. Go to step 8 when all the songs in the Song_name link list are processed.

Stage 3:
Trace the link lists to generate and write the Sorted ID Lists, the Associated ID Lists, and the Num_of_songs Lists into the flash memory storage.
First, we generate the sorted ID lists and store them in the Flash memory by tracing the Song Name Link List, Album Name Link List, Artist Name Link List and Genre Name List List.
Then, we generate the Association Lists and store them in the flash memory using the following flowchart:
   1) Trace the Album Name Link List and for the album, denoting its ID as curAlbID,
      2) Set Num_of_song=0
      3) nextSongID=Alb_Head_ptr(curAlbID)
      4) If (nextSongID) is equal to “EOL”, jump to step 8
      5) append nextSongID to the Album-Song ID List in the Flash
      6) increment Num_of_song
      7) nextSongID=SAlbID(nextSongID) and go back to step 4
      8) Append Num_of_song in the Tot_Song_in_Album List in the Flash.
   9) trace to the next album and repeat from step 2 until all the album in the Album Name Link List is exhausted.
   Repeat step 1 to 9 for Artist and Genre to generate the Artist-Song ID List and the Genre-Song ID List in the Flash.

An important aspect of the present invention in this patent is the way these lists are organized in the memory during the building process. While all the lists are eventually generated and stored in the flash memory (or slow memory), only the Name Lists are stored in the flash memory during the building process. When each song name, album name, artist name and genre name are obtained from the song file, these names are written into these Name Lists in the flash directly. All the other lists including the Sorted ID Lists, Association ID Lists, and Num_of_Songs Lists are all stored in the internal RAM (or fast memory) during the building process.

As a new song is added to the database, the song ID has to be inserted in the sorted ID Lists by binary searching for the position of insertion. In this process, the Song Name List of previously added songs has to be retrieved from the flash memory (slow memory) and this is a fairly slow process. In preferred embodiments of the present invention, an Anchored Point Table is created in the internal RAM (fast memory) that stores the song names (or the first 10 characters of the song names) of selected entries in the Song Name List. These entries are selected such that the spacing between them in the sorted ID list will not be more than 32. With this Anchored Point Table, the algorithm can first do a binary search on this Anchored Point Table to determine the rough position of insertion and this can be done using only internal memory. Then, once the anchored point is located, the algorithm will do a binary search for the songs between two anchored points. Since there are at most 32 entries between 2 anchored points, the number of slow memory access is limited to 5=log₂(32). Of course, the number 32 can be changed depending on the total number of songs allowed in the system as well as the size of the RAM size allocated for the Anchored Point Table. The use of this Anchored Point Table will shortened the building time significantly.

What we claim is:

1. A method of building a database of multimedia files designed to provide a fast algorithm to build the database in a digital multimedia device with large capacity storage media, but with a relatively slow access time but with a very limited amount of fast RAM memory space.

2. A method of building a database of multimedia files stored in slow memory using metadata of the multimedia files in a multimedia player running on a processor with fast memory and slow memory, the method comprising the steps of:
retrieving the metadata from each multimedia file residing in the slow memory only once; and
storing the retrieved metadata in an array in a database in the slow memory directly and only once.
